(19) United States
(12) Patent Application Publication
(10) Pub. No.: US 2015/0292530 A1
(43) Pub. Date: Oct. 15, 2015

(54) MECHANICAL ACTUATOR

(71) Applicants: Roger SJÖBECK, Malmö (SE); Magnus IVARSSON, Malmö (SE)

(72) Inventors: Roger Sjobeck, Malmo (SE); Magnus Ivarsson, Malmo (SE)

(21) Appl. No.: 14/443,070

(22) PCT Filed: Nov. 15, 2012
(86) PCT No.: PCT/EP2012/072664

§ 371 Date: May 14, 2015

(51) Int. Cl. F15B 15/14; B02C 1/02

(52) U.S. Cl. CPC F15B 15/1461; B02C 1/025

(57) ABSTRACT

A mechanical actuator configured to prevent the ingress of contaminant particulates from propagating under the cylinder head to destroy the fluid tight seal at the actuator chamber. An annular collar is tethered to an outer end region of the cylinder barrel and includes at least one scraper and seal to provide a preliminary cleaning of the piston rod.

### FIELD OF INVENTION

The present invention relates to a mechanical actuator and in particular, although not exclusively, to a moveable jaw crusher actuator positioned between a region of a moveable jaw and a jaw support frame of a jaw crusher.

### BACKGROUND ART

Jaw crusher units typically comprise a fixed jaw and a movable jaw that define a crushing zone therebetween and a drive mechanism operative to rock the movable jaw back and forth in order to crush material in the crushing zone.

The crushing zone is generally convergent towards its lower discharge end so that crushable material fed to the upper and wider end of the zone is capable of falling downward under gravity whilst being subject to repeated cycles of crushing movement in response to the cyclical motion of the movable jaw. The crushed material is then discharged under gravity through the lower and narrower discharge end onto a conveyor belt for onward processing or discharge from the crusher unit to a suitable stock pile.

Commonly, the frame that supports the fixed jaw is referred to as the front frame end. The moveable jaw is connected to what is typically referred to as a back frame end via a mechanically actuated link mechanism that serves to control and stabilise the oscillating movement of the jaw relative to the stationary jaw. Typically, the link mechanism is both statically and dynamically linearly adjustable to control the grade or size of the resultant crushed material, to facilitate absorption of the impact forces generated by the crushing action and to expand or open the crushing zone to prevent damage to the crusher in the event of non-crushable material being accidentally introduced into the crushing zone.

Example jaw crushers comprising linkage assemblies connecting the back frame and front frame ends are described in FR 2683462; EP 0773067; WO 97/36683; U.S. Pat. No. 5,799,888; WO 02/34393; WO 2008/010072, JP 2009-297591 EP 0148780, JP 60-251941, U.S. Pat. No. 7,143,970 and CN 2832296.

Jaw crushers of the types identified above typically include a retraction or tension assembly mounted at a lower region of the moveable jaw and being operative to set or control the separation distance of the moveable jaw and the fixed jaw. This is useful to selectively adjust the jaw separation distance to either accommodate larger rocks within the crushing zone or allow passage of uncrushable material to exit the crusher and avoid damage. In some cases, a hydraulic actuator is used to mechanically separate the jaws in which a piston rod acts upon a piston that slides within a cylindrical barrel. Typically, these retraction cylinders require a sealing-like scraper at the barrel end that functions to wipe particulate dust and debris from the piston rod surface before it passes in contact with O-rings and sealing gaskets. However, due to the very dusty and dirty working environment of the cylinder, integrity of the scraper and the neighbouring piston seals is degraded quickly by the particulate matter entrapped by the oil at the external surface of the piston rod. Notwithstanding manufacturer quoted lifetime, a typical retraction cylinder requires servicing and/or replacement at around a thousand hours of service. The frequency of repairs and the down-time for a repair of a retraction cylinder continues to be a significant problem with conventional jaw crusher. What is required is a mechanical actuator and a jaw crusher that addresses the above problems.

### SUMMARY OF THE INVENTION

It is an objective of the present invention to provide a mechanical actuator that is effective to prevent contaminant materials and particulates from being carried on an elongate rod to contaminate and/or accelerate wear of sealing rings, gaskets or bearings mounted about the rod. It is therefore a further objective to extend, as far as possible, the operational lifetime of a mechanical actuator that forms part of a jaw crusher prior to replacement or repair due to worn O-rings, bearings and/or gasket seals.

The objective is achieved by an additional collar-like shuttle mounted about the rod and positioned to one side of the main piston barrel to function as a first stage debris scraper to inhibit and prevent particulate matter adhered to the external surface of the rod passing into the piston barrel and in contact with the seals of the piston chamber.

Advantageously, the shuttle comprises a scraper positioned in close fitting contact with the rod outer surface. The shuttle is spaced apart from the main piston barrel and in one mode is positionally locked to the rod so as to shuttle back and forth in the longitudinal axis direction with the rod (over relatively short distances) in response to the cyclical movement of the swing jaw during crushing operations. A flexible bellows provides an external bridge or cover between the shuttle and the actuator barrel to prevent dirt and other debris from passing into the region between the shuttle and the barrel end. In this configuration, the annular collar is tethered to an outer end region of the cylinder barrel. The region of the rod that extends immediately outwardly from the barrel is therefore covered and protected from particulate contamination by the shuttle and the bellows. A scraper positioned at the barrel end functions to prevent any residual particulate matter from passing into the barrel interior beyond a barrel head. This barrel scraper therefore provides a secondary cleaning action to that of the annular collar.

The collar is detachably mounted at the barrel and is conveniently detached from the actuator assembly to allow rapid and convenient repair or replacement without the need to disassemble the actuator main body that includes the barrel, rod, cylinder head and internal seals.

According to a first aspect of the present invention there is provided a mechanical actuator comprising: an elongate rod; a body mounted about an external surface of the rod; characterised by: at least one collar mounted at the external surface of the rod to one side of the body, the collar comprising at least one scrapper in close fitting contact with the external surface of the rod, the collar capable of sliding movement over the rod; and bellows attached to a region of the body to provide an external cover for the rod at a region between the collar and the body.

Optionally, the actuator is configured to provide a pulling and/or pushing force, wherein the body comprises: a barrel having an internal surface defining an internal barrel chamber; a piston housed within the chamber and capable of reciprocating linear sliding movement against the internal surface; the rod attached to the piston and capable of longitudinal reciprocating extension and retraction relative to the barrel; a head mounted between an external surface of the rod and the internal surface of the barrel, the head comprising at least one seal to provide a fluid type seal of the chamber at the region of the rod and the head.

Optionally, the body may comprise: a bearing assembly mounted about the rod and capable of reciprocating linear sliding movement over an external surface of the rod; the collar mounted at the external surface of the rod to one side of the bearing assembly; and wherein the bellows are attached to a region of the bearing assembly to provide an external cover for the rod at a region between the collar and the bearing assembly.

Advantageously, the scraper is configured for sealing against the outer surface of the rod and may be regarded a seal or gasket. Accordingly, the scraper acts to prevent any particulate matter adhered to the outer surface of the rod from passing axially beyond the scraper. According to specific embodiments, the scraper may comprise a material that is self-lubricating and may comprise a length in the longitudinal axis direction of the rod that is sufficient to prevent passage of particulates from one side of the scraper to another. Preferably, the collar further comprises a seal and/or a guide ring.

Preferably, the collar is spaced apart from an end region of the body in a direction of the longitudinal axis of the rod. Preferably, the collar is positioned immediately adjacent the body (barrel end, bearing and/or the cylinder head) and is tethered to the body via the bellows.

Optionally, a region of the collar comprises a radial length relative to a longitudinal axis that is substantially equal to a radial length of a region of the body where the bellows are attached. Optionally, a region of the collar comprises a substantially identical or near identical shape and configuration to an end region of the head positioned at an end region of the barrel. Optionally, the head comprises a scraper and the collar comprises a scraper, the head scraper comprising a shape and configuration that is substantially identical or near identical to a shape and configuration of the collar scraper.

Preferably, the scraper extends from one side of the collar and is positioned furthest from the body in a longitudinal axis direction of the rod.

Optionally, the actuator comprises at least one seal positioned behind the scraper in the longitudinal axis direction of the rod.

Preferably, the bellows comprise a flexible material to allow movement of the collar in a longitudinal axis direction of the rod to and from the body.

Preferably, the actuator comprises a first clamp to secure the bellows to the collar and a second clamp to secure the bellows to a region of the body.

Preferably, in a first mode the collar is configured to pinch onto the external surface of the rod and move back and forth with the rod as a coupled unit. In a second mode the collar is configured to slide over and external surface of the rod. The collar is configured to switch between the first and second modes automatically in response to the magnitude (distance) of the axial movement of the rod relative to the main body. When the rod is moving in a first axial direction, the bellows acts as a tether to anchor the collar at the main body and prevent the collar sliding away from the main body beyond a predetermined distance. Additionally, when the rod is moving in the opposite axial direction the main body acts as a stop to break the couple between the collar and the rod to allow the rod to slide through the collar.

Optionally, the actuator comprises: at least two collars, at least a first collar positioned at a first side of the bearing assembly and at least a second collar positioned at a second side of the bearing assembly; a first bellows attached to the first collar and the bearing assembly and a second bellows attached to the second collar and the bearing assembly, the first and second bellows providing an external cover for the rod at the regions between the collars and the bearing assembly.

According to a second aspect of the present invention there is provided a jaw crusher retraction actuator positioned between a region of a moveable jaw and a support frame for the moveable jaw, the actuator comprising: a barrel having an internal wall defining an internal barrel chamber; a piston housed within the chamber and capable of reciprocating linear sliding movement against the internal wall; a piston rod attached to the piston and capable of longitudinal reciprocating extension and retraction relative to the barrel; a head mounted between an external surface of the rod and the internal wall of the barrel, the head comprising at least one seal to provide a fluid type seal of the chamber at the region of the rod and the head; characterised by: a collar mounted at the external surface of the rod to one side of the barrel, the collar comprising at least one scrapper in close fitting contact with the external surface of the rod, the collar capable of sliding movement over the rod; and bellows attached to the collar and the barrel and/or head to provide an external cover for the rod at a region between the collar and the barrel and/or the head.

According to a third aspect of the present invention there is provided a jaw crusher comprising a mechanical actuator as described herein. Preferably, the mechanical actuator is positioned between a moveable jaw of the crusher and a support frame to support the moveable jaw.

Optionally, the mechanical actuator may comprise a plurality of collars, each collar having respective scrapers and seals. Preferably, each collar is spaced apart in the longitudinal axis direction and is positioned side-by-side in-series adjacent other collars, with an end collar being positioned adjacent the cylinder head. Optionally, the actuator comprises a single elongate bellows or separate relatively shorter bellows to form the radially outermost connective covers to tether each respective collar to form a unitary, in-series assembly.

### BRIEF DESCRIPTION OF DRAWINGS

A specific implementation of the present invention will now be described, by way of example only, and with reference to the accompanying drawings in which:

FIG. 1 is cross-sectional side elevation view of a jaw crusher in which a moveable jaw is positioned in opposed relationship to a stationary jaw and is positionally supported by a back frame end via a mechanically actuated linkage assembly according to a specific implementation of the present invention;

FIG. 2 is a side external view of a mechanical actuator comprising a scraping shuttle positioned to one side of a cylinder barrel and mounted about a piston rod according to a specific implementation of the present invention;

FIG. 3 is a cross section through A-A of FIG. 2;

FIG. 4 is a magnified view of region B of the linear actuator of FIG. 3 including the shuttle and an end region of the barrel and cylinder head;

FIG. 5 is a cross sectional side view of a mechanical actuator comprising a first scraping collar and a second scraping collar positioned either side of a bearing assembly according to a further specific implementation of the present invention.

### DETAILED DESCRIPTION OF PREFERRED EMBODIMENTS OF THE INVENTION

The present mechanical actuator is suitable for use on a wide range of apparatus optionally to provide linear actuation via a pushing or pulling action or to function as a bearing assembly. The mechanical actuator is particularly adapted for use in harsh working environments such as mining, quarrying and mineral processing industries and in particular to form part of larger crushing, screening, sieving and conveying apparatus.

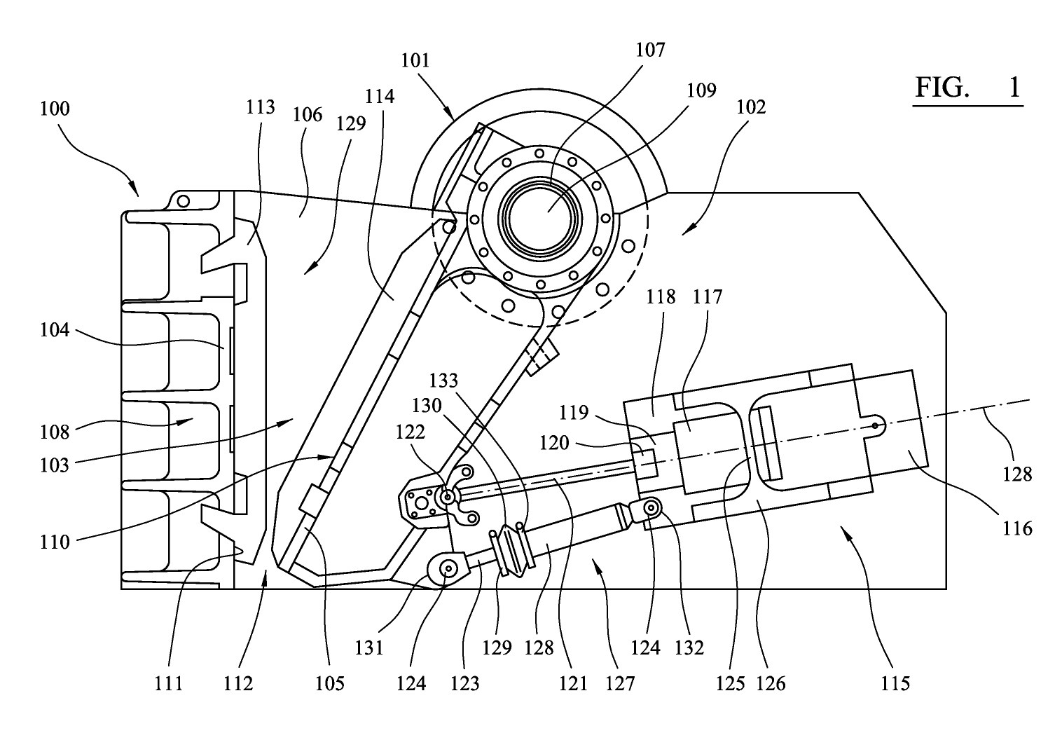

The present linear actuator is particularly suited for use with a jaw crusher to form part of a mechanical linkage assembly connecting a moveable jaw to a frame part of the jaw. According to one specific utilisation and by way of example referring to FIG. 1, a jaw crusher unit 100 comprises a main frame 102 upon which is mounted a moveable jaw 105 and a substantially fixed jaw 104. The movable jaw 105 is mounted eccentrically at a rotatable shaft 107 (extending from underneath an end cap 109) and is positioned separated and opposed to fixed jaw 104. The orientation of fixed jaw 104 and movable jaw 105 relative to one another is convergent along their respective lengths such that a separation distance between a crushing face 111 of fixed jaw 104 and a corresponding crushing face 110 of movable jaw 105 decreases in the downward lengthwise direction. A suitable wear plate 113 is removably attached to crushing face 111 of fixed jaw 104 and a corresponding wear plate 114 is removably attached to crushing face 110 of movable jaw 105. Main frame 102 comprises two opposed frame walls that support the front frame end 108, which is aligned substantially perpendicular to frame walls 102. The side walls extend either side of fixed jaw 104 and movable jaw 105 to collectively define a crushing zone 103.

The opposed fixed and movable jaws 104, 105 are oriented to be inclined relative to one another and are spaced apart further at their respective upper ends than their lower ends. Accordingly, the crushing zone 103 is convergent from an upper feed region 129 to a lower discharge region 112.

A pair of pulley wheels 101 are mounted either end of shaft 107 at an external facing side of side frame walls 102 being external to the crushing zone 103. Movable jaw 105 is thereby configured for gyroscopic or eccentric motion with respect of fixed jaw 104 as pulley wheels 101 and shaft 107 are rotated via a suitable drive belt (not shown) attached to a drive motor (not shown). This movement of jaw 105 provides the necessary crushing action for material within zone 103 between the opposed wear plates 113 and 114. Material to be crushed is introduced into zone 103 via the open upper region 129 where it is crushed between jaws 104, 105 and subsequently discharged via the open lower region 112. A plurality of removably mounted side liners 106 are attached to each side frame wall 102 at the region of crushing zone 103.

The moveable jaw 105 is supported by a back frame end 115. In particular, a support frame 118 mounts a mechanically actuated link assembly that is coupled to a lower region of moveable jaw 105 so as to support and stabilise the oscillating movement of jaw 105 and control the separation distance between the opposed wear plates 113, 114. The link assembly comprises a collapsible link member, in the form of a substantially planar toggle plate 121 coupled at one side to moveable jaw 105 via a seating bush 122. A second side of toggle plate 121 is secured at a second seating bush 120 mounted within a guide block assembly 119. A piston 117 is aligned coaxially with and abuts against guide block 119. A hydraulic thrust-bearing cylinder 116 is coupled with piston 117 to provide a hydraulic ram assembly to absorb and transmit the loading forces imparted to the back frame end 115 by moveable jaw 105. Frame 118 comprises a force transmission wall 125 aligned substantially perpendicular to the axis of the link assembly. Wall 125 is reinforced at its respective upper and lower ends (when oriented in normal use) by respective reinforcement regions. Toggle plate 121 acts as a collapsible connecting member that connects the rear support frame 118 to the movable jaw 105 such that jaw 105 is retained in floating manner with respect to main frame 102 and stationary jaw 104 to allow moveable jaw 105 to freely oscillate by the reciprocating motion induced by shaft 107.

A retraction assembly 127 is attached at a first end to a lower region of moveable jaw 105 via a mounting 131 and a first bearing 124. A second end of assembly 127 is mounted at frame 118 via mounting 132 and a corresponding bearing 124. Retraction assembly 127 comprises a barrel 128 at least partially housing a piston rod 123 capable of linear extension and retraction relative to a body, in the form of a barrel 128 to form a hydraulic cylinder.

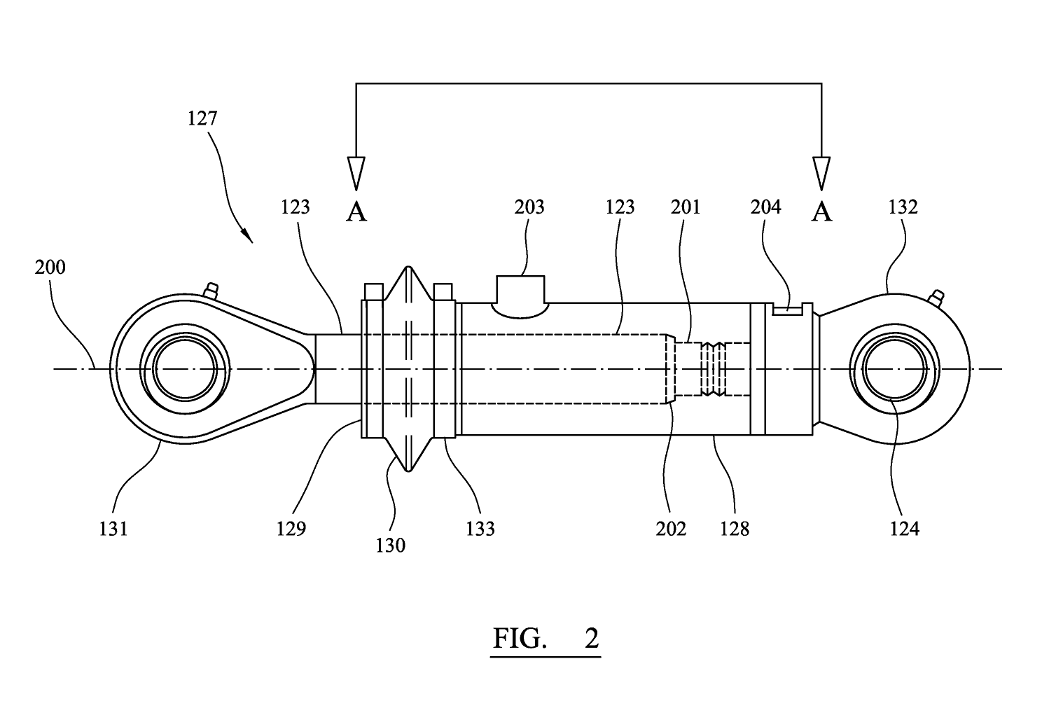

Referring to FIGS. 1 to 4, retraction cylinder 127 further comprises a collar-like shuttle 129 mounted about rod 123 in floating position relative to body (barrel) 128. Shuttle 129 is tethered to an end region 133 of barrel 128 via a flexible and deformable bellows 130. Shuttle 129 is clamped in position about rod 123 with a radially compressive force sufficient to allow shuttle 129 to pinch against an outside surface 404 of rod 123 in a first mode of operation but also to allow rod 123 to extend and retract lineally relative to barrel 128 and shuttle 129 in a second mode.

Piston rod 123 comprises longitudinal axis 200 and is aligned coaxially with barrel 128. A first end of rod 123 terminates at mounting 131 whilst a second end 202 comprises a section 201 of reduced diameter configured for mounting within and attachment to a piston 301. Section 201 therefore provides a coupling between piston 301 and rod 123. Piston 301 comprises an external facing surface 315 configured to mate with an internal facing surface 303 of barrel 128. Surface 303 defines an elongate internal chamber 300 within which piston 301 is capable of sliding in the longitudinal axis direction 200 in contact with surface 303. A plurality of seals 302 are provided concentrically at external facing surface 315 to provide a fluid tight seal between surface 315 and surface 303. An end region 316 of barrel 128 positioned immediately adjacent mounting 132 comprises a first chamber port 204 to allow fluid exchange with chamber 300 at the side of piston 301 closest to end 316. A second fluid port 203 provides a means of fluid communication into chamber 300 at an opposite side of piston 301 adjacent a barrel end 314.

A cylinder head 305 is mounted about rod 123 at the region of barrel end 314. In particular, a portion of head 305 is positioned intermediate between the outer surface 404 of rod 123 and inner surface 303 of barrel 128. Additionally, a portion of head 305 extends axially beyond barrel end 314 so as to protrude from barrel 128. Head 315 comprises a plurality of seals 306 arranged concentrically at the innermost region of head 305 in contact with outer surface 404. A second end 309 of head 305 is configured for positioning within chamber 300 to abut a sealing gasket 304. A first end 308 of head 305 comprises an annular seal in a form of a scraper 307. A portion of scraper 307 is positioned in-board of head end 308 whilst a region 405 extends a short axial distance beyond end 308 to taper radially inward from end 308 to axis 200. The underside of scraper 406 is positioned in contact with rod outer surface 404.

The shuttle 129 comprises an annular body that extends a short distance in the longitudinal axis direction 200. Shuttle 129 is dimensioned so as to sit around rod surface 404 in a similar manner to cylinder head 305. The axial length of shuttle 129 is approximately one third of the length of cylinder head 305 whilst its radial length is approximately equal to the radial length of an end region of cylinder head 305. In particular, shuttle body 129 is substantially identical to an end region of cylinder head 305.

Shuttle body 129 comprises a ribbed or grooved inner surface 409 to accommodate intermediate bodies including in particular a scraper 311, a seal 312 and a guide ring 313. Scraper 311 is substantially identical to scraper 307 retained at the underside surface of the cylinder head 305. That is, a region 408 of scraper 311 is sandwiched between shuttle body 129 and rod outer surface 404. Additionally, a section 402 projects forwardly of an outermost end 403 of shuttle 129 and tapers inwardly from shuttle 129 towards axis 200. An O-ring 312 is positioned immediately behind scraper 311 and a guide ring 313 is positioned immediately behind O-ring 312 in the longitudinal direction 200. Shuttle 129 is separate and physically spaced apart from cylinder head 305 in the longitudinal axis direction 200 by distance C.

The gap region C is covered via external bellows 130 so as to enclose the space between shuttle body 129 and cylinder head 305. Bellows 130 comprises an annular configuration having a first end edge 410 and a second end edge 411. The central region of bellows 130 is domed radially outward and comprises a typical bellows configuration having a peak and trough profile in the external facing surface. According to the specific implementation, bellows 310 comprises a single peak 412. However, according to further specific implementations, bellows 130 may comprise a plurality of peaks and troughs to form a corrugated or ribbed profile. Bellows 130 comprises a flexible deformable material such as a polymer and in particular rubber, or synthetic leather. A first region of bellows 130 towards first edge 410 is anchored at shuttle body 129 via an adjustable clamp 310. A similar and corresponding clamp 310 anchors bellows 130 (at a region towards second edge 411) to a radially outermost surface of cylinder head 305 (that projects axially beyond barrel end 314). Clamps 310 are configured to prevent any longitudinal slip between bellows 130 and the radially outer surfaces of shuttle 129 and cylinder head 305. By adjusting and setting the compressive force created by clamp 310 that acts radially inward through shuttle body 129, scraper 311, seal 312 and guide ring 313 are retained in touching contact against outer surface 404 such that shuttle 129 grips and locks onto the rod outer surface 404. Accordingly, shuttle 129 is configured to move axially with rod 123 over the short reciprocating axial distances as moveable jaw 105 swings back and forth during crushing operations relative to fixed jaw 104. Accordingly, bellows 130 deforms radially outward during compression strokes as shuttle body 129 is moved towards cylinder head 305. Likewise, bellows 130 is drawn radially inward as it elongates during extension strokes as shuttle 129 moves away from cylinder head 305.

However, the clamping compressive force imparted by clamp 310 is such that when rod 123 undergoes appreciable extension from barrel 128, bellows 130 acts as a tether to retain shuttle 129 at a maximum separation distance from cylinder head 305. Similarly, during significant and reverse retraction strokes, the end surface 401 of shuttle 129 is brought into contact with the end surface 308 of cylinder head 305 to release the locking contact between shuttle 129 and rod outer surface 404 to allow rod 123 to slide within shuttle 129. When these significant extension and retraction strokes are completed, shuttle 129 automatically returns to the temporary locking configuration in contact with outer surface 404.

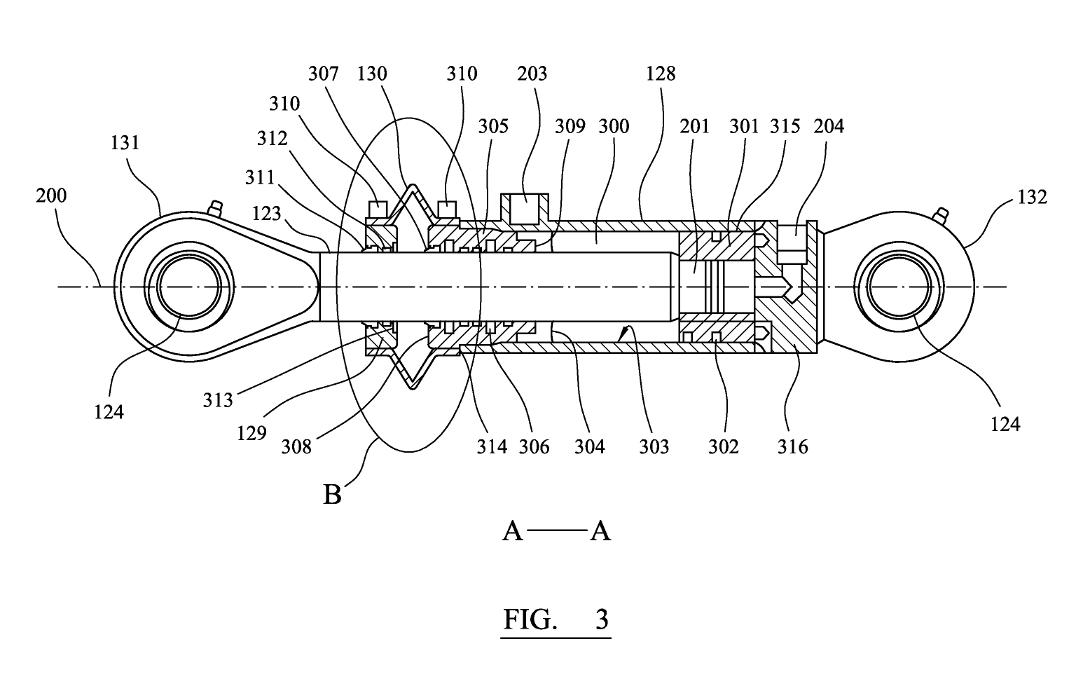

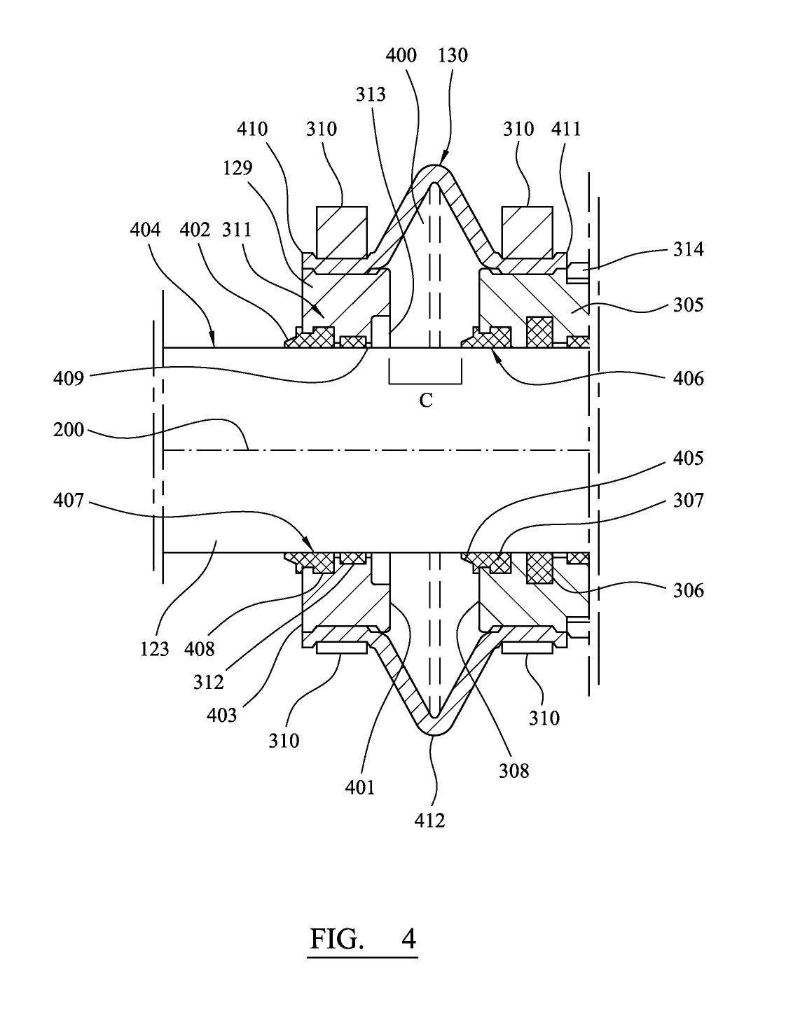

According to the specific implementation, scrapers 311, 307 and seals 312, 306 comprise a rubber material whilst guide ring 313 comprises a metal or plastic gasket. According to further specific implementations, scrapers 311, 306 may comprise any material suitable to slide against external surface 404 and to wipe debris and particulate matter from surface 404. With the present configuration, scraper 311 provides an initial or preliminary seal to prevent contaminant from passing from left to right and into contact with cylinder head seals 306 as illustrated in FIGS. 3 and 4. Should any residual contaminant pass beyond shuttle 129, scraper 307 functions to prevent such residues from progressing axially towards chamber seals 306. Bellows 130 is effective to prevent any contaminant entering zone 400 between shuttle 129 and cylinder head 305. As the volume of zone 400 is maintained to a minimum given the relatively short separation distance C, any suction force created during expansion of zone 400 (during extension of rod 123 from barrel 128) is maintained to a minimum. This is to be contrasted with conventional bellows arrangements that extend a much greater axial distance and create much larger suction forces that act to draw-in particulates into zone 400.

According to further specific implementations, the mechanical actuator may comprise a plurality of shuttle bodies 129 and corresponding scrapers and seals 311, 312, 313 with each shuttle being spaced apart and positioned side-by-side in series adjacent other shuttles 129, with an end shuttle being positioned adjacent cylinder head 305. Such a configuration provides multiple, preliminary scraping means (and seals) to prevent the ingress of contaminants passing upstream into contact with the inner chamber seals 306 at cylinder head 305. A single elongate bellows or separate relatively shorter bellows may be provided to form the radially outermost connective covers and tethers to extend and link each respective shuttle 129 of the series.

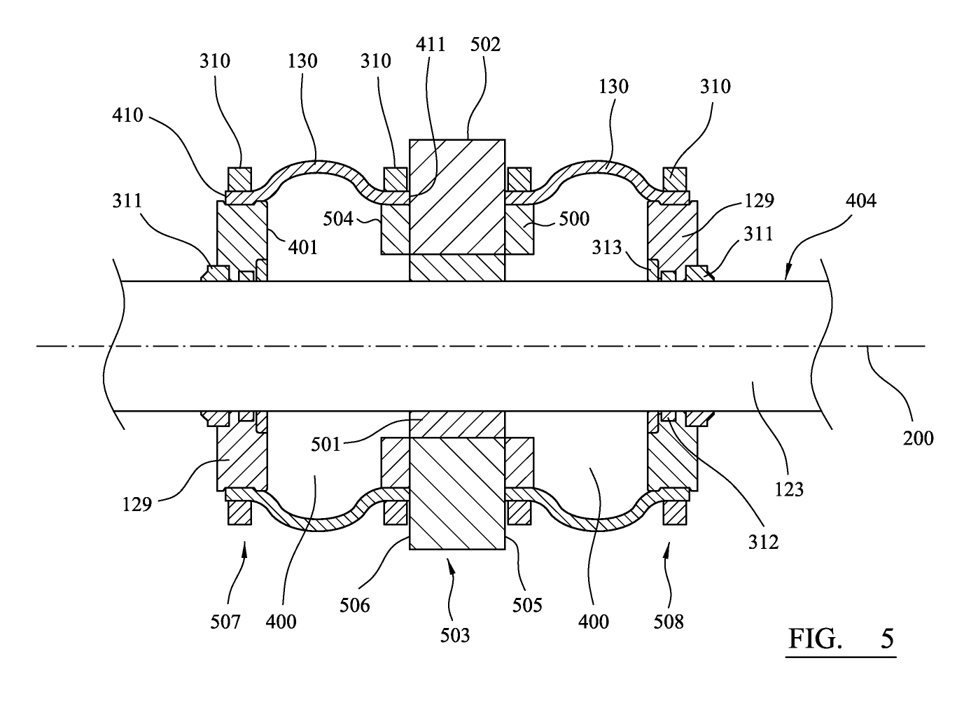

According to a further specific implementation, the debris wiping collar assembly as described referring to FIGS. 1 to 4 may be used to form part of a bearing assembly as illustrated in FIG. 5. In particular, a bearing assembly 503 comprises a main body 502 having a generally annular configuration to surround elongate rod 123. A bearing, such as a racer bearing 501 is positioned radially between annular main body 502 and outer surface 404 of rod 123 (relative to longitudinal axis 200 of rod 123). A first mounting flange 500 extends axially from a first face 505 of main body 502 and a second and corresponding mounting flange 500 extends axially from a second opposed face 506 of body 502.

A first collar assembly 507 is positioned axially to one side of bearing assembly 503 and a second collar assembly 508 is positioned at a second side of bearing assembly 503. Each collar assembly 507, 508 is axially spaced from the intermediate bearing 503 to create intermediate zones 400 defined, in part, by the respective end surfaces 401 of each collar 129 and the opposed end surfaces 504 of mounting flanges 500. As described with reference to the first embodiment (FIG. 4), each collar 129 comprises a scraper 311, a seal 312 and a guide ring 313 in contact with the external surface 404 of rod 123.

Bearing assembly 503 is coupled to each collar assembly 507 and 508 via respective bellows 130. A first end region 410 of each bellow 130 is secured at each collar 129 via the same clamp arrangement 310 described referring to the first embodiment of FIG. 4. Similarly, a second end region 411 of bellows 130 is attached at bearing assembly 503 at flange 500 using the same clamp arrangement 310. Accordingly, each collar assembly 507, 508 is tethered to the axially intermediate bearing assembly 503 via flexible bellows 130. In use, as the bearing 503 slides axially over surface 404, the collar assemblies 507, 508 are effective to wipe any particulate debris from surface 404 to prevent such debris from contacting bearing 501. As will be appreciated, main body 502 may be coupled in parallel with a plurality of adjacent bearing and collar assemblies (503, 507, 508) each assembly mounted upon a respective rod 123, with each rod aligned parallel such that the bearing and collar assemblies are mechanically linked to be actuated as one unit forming part of a larger mechanical structure.

Additionally, and according to further specific implementations, each bearing assembly 503 may comprise a plurality of collar assemblies 507, 508 positioned axially to each side face 505, 506. That is, the arrangement of FIG. 5 may comprise between one to ten collar assemblies positioned to the right hand side of face 505 and between one to ten collar assemblies 507 extending axially in-series to the left side of face 506. Accordingly, each of the collar assemblies, to either side of main bearing assembly 503 would be tethered to each other via a single or separate bellows 130.

1. A mechanical actuator comprising:
an elongate rod;
a body mounted about an external surface of the rod;
at least one collar mounted at the external surface of the rod to one side of the body, the collar including at least one scrapper in close fitting contact with the external surface of the rod, the collar being capable of a sliding movement over the rod; and
bellows attached to a region of the body to provide an external cover for the rod at a region between the collar and the body.

2. The actuator as claimed in claim 1, configured to provide a pulling and/or pushing force, wherein the body comprises:
a barrel having an internal surface defining an internal barrel chamber;
a piston housed within the chamber and capable of reciprocating linear sliding movement against the internal surface, the rod being attached to the piston and capable of longitudinal reciprocating extension and retraction relative to the barrel
a head mounted between an external surface of the rod and the internal surface of the barrel, the head including at least one seal to provide a fluid type seal of the chamber at the region of the rod and the head.

3. The actuator as claimed in claim 1, wherein the body comprises:
a bearing assembly mounted about the rod and capable of reciprocating linear sliding movement over an external surface of the rod;
the collar mounted at the external surface of the rod to one side of the bearing assembly; and
wherein the bellows are attached to a region of the bearing assembly to provide an external cover for the rod at a region between the collar and the bearing assembly.

4. The actuator as claimed in claim 1, wherein the collar is spaced apart from an end region of the body in a direction of the longitudinal axis of the rod.

5. The actuator as claimed in claim 1, wherein the collar further comprises a seal and/or a guide ring.

6. The actuator as claimed in claim 1, wherein a region of the collar includes a radial length relative to a longitudinal axis that is substantially equal to a radial length of a region of the body where the bellows are attached.

7. The actuator as claimed in claim 2, wherein a region of the collar includes a substantially identical or near identical shape and configuration to an end region of the head positioned at an end region of the barrel.

8. The actuator as claimed in claim 2, wherein the head (305) includes a scraper and the collar includes a scraper, the head scraper having a shape and configuration that is substantially identical or near identical to a shape and configuration of the collar scraper.

9. The actuator as claimed in claim 8, wherein the scraper extends from one side of the collar and is positioned furthest from the body in a longitudinal axis direction of the rod.

10. The actuator as claimed in claim 1, wherein the bellows include a flexible material to allow movement of the collar in a longitudinal axis direction of the rod to and from the body.

11. The actuator as claimed in claim 1, comprising a first clamp to secure the bellows to the collar and a second clamp to secure the bellows to a region of the body.

12. The actuator as claimed in claim 1, wherein the collar is pinched on the external surface of the rod and move back and forth over an external surface of the rod.

13. The actuator as claimed in claim 3 further comprising at least two collars, at least a first collar positioned at a first side of the bearing assembly and at least a second collar positioned at a second side of the bearing assembly; a first bellows attached to the first collar and the bearing assembly and a second bellows attached to the second collar and the bearing assembly, the first and second bellows providing an external cover for the rod at the regions between the collars and the bearing assembly.

14. A jaw crusher retraction actuator positioned between a region of a moveable jaw and a support frame for the moveable jaw, the actuator comprising:
a barrel having an internal surface defining an internal barrel chamber;
a piston housed within the chamber and capable of reciprocating linear sliding movement against the internal surface;
a piston rod attached to the piston and capable of longitudinal reciprocating extension and retraction relative to the barrel;
a head mounted between an external surface of the rod and the internal surface of the barrel, the head including at least one seal to provide a fluid type seal of the chamber at the region of the rod and the head;
a collar mounted at the external surface of the rod to one side of the barrel, the collar including at least one scrapper in close fitting contact with the external surface of the rod, the collar being capable of sliding movement over the rod; and
bellows attached to the collar and the barrel and/or head to provide an external cover for the rod at a region between the collar and the barrel and/or the head.

15. A jaw crusher comprising: a mechanical actuator, the mechanical actuator including an elongate rod, a body mounted about an external surface of the rod, at least one collar mounted at the external surface of the rod to one side of the body, the collar including at least one scrapper in close fitting contact with the external surface of the rod, the collar being capable of a sliding movement over the rod, and bellows attached to a region of the body to provide an external cover for the rod at a region between the collar and the body.
